(19) United States
(12) Patent Application Publication
(10) Pub. No.: US 2022/0219975 A1
(43) Pub. Date: Jul. 14, 2022

(54) STEAM REFORMING WITH CARBON CAPTURE

(71) Applicant: ZONEFLOW REACTOR TECHNOLOGIES, LLC, Windsor, CT (US)

(72) Inventor: Jonathan Jay Feinstein, Windsor, CT (US)

(21) Appl. No.: 17/709,175

(22) Filed: Mar. 30, 2022

Related U.S. Application Data
(63) Continuation of application No. PCT/US2021/071206, filed on Aug. 17, 2021.
(60) Provisional application No. 63/066,467, filed on Aug. 17, 2020.

(51) Int. Cl. C01B 3/38; B01J 19/24; C01B 3/50; C01B 32/50; B01D 53/14; B01D 53/047

(52) U.S. Cl. CPC C01B 3/38; B01J 19/2465; C01B 3/506; C01B 3/508; C01B 32/50; B01D 53/1475; B01D 2257/504; C01B 2203/0233; C01B 2203/042; C01B 2203/0822; C01B 2203/148; B01D 2252/204; B01D 2257/108; B01D 53/047

(57) ABSTRACT

Steam reforming processes can include treatment of syngas by water gas shift, water separation, and hydrogen separation by pressure swing adsorption (PSA). Additionally, CO₂ can be scrubbed from the syngas prior to the PSA. PSA tail gas, including CH₄, CO, and H₂, can be recompressed and recycled to the PSA for further hydrogen separation and to the steam reformer feed to convert eventually all carbon in the feedstock into CO₂ for the scrubber to separate. Fuel requirements can be fulfilled by part of the hydrogen product to eliminate stack CO₂ emissions. The hydrogen used as fuel is heated and turbo-expanded to provide power before being combusted as fuel. A nitrogen purge may be added.

### CROSS-REFERENCE TO RELATED APPLICATIONS

This application is a continuation of PCT International Application No. PCT/US2021/071206, filed Aug. 17, 2021, titled “STEAM REFORMING WITH CARBON CAPTURE,” which claims the benefit of U.S. Provisional Application Ser. No. 63/066,467, filed Aug. 17, 2020, titled “STEAM REFORMING WITH CARBON CAPTURE,” both of which are incorporated by reference herein in their entirety.

### FIELD

The present disclosure relates to systems and methods for the production of hydrogen by steam reforming.

### SUMMARY

In a first aspect, a method of producing hydrogen comprises reforming a mixture of a steam and a feedstock containing carbon and hydrogen in a steam reforming unit to produce syngas comprising hydrogen, carbon dioxide, and at least one of methane and carbon monoxide; separating the syngas in at least one separation unit into a carbon dioxide rich stream, a hydrogen rich stream, and a tail gas stream containing remaining contents of the syngas; and converting at least a portion of the tail gas stream to hydrogen and carbon dioxide.

In some embodiments, the at least a portion of the tail gas is recycled to the steam reforming unit wherein the at least a portion of the tail gas is converted to hydrogen and carbon dioxide. In some embodiments, nitrogen is separated from the at least a portion of the tail gas before the at least a portion of the tail gas is recycled to the steam reforming unit.

In some embodiments, water is separated from the syngas in a water separator to produce an outlet stream of water and a stream containing remaining contents of the syngas entering the water separator.

In some embodiments, at least a portion of the hydrogen rich stream is used as a combustion fuel for the steam reforming unit. In some embodiments, the at least a portion of the hydrogen rich stream is turbo-expanded to perform work before being used as the combustion fuel. In some embodiments, a temperature of the at least a portion of the hydrogen rich stream is increased by at least 50° C. before being turbo-expanded.

In some embodiments, the carbon dioxide rich stream is separated from the syngas in a carbon dioxide separation unit, wherein the hydrogen rich stream is separated from remaining syngas in a hydrogen separation unit having the hydrogen rich outlet stream and the tail gas outlet stream, and wherein at least a portion of the tail gas stream from the hydrogen separation unit is compressed and fed into the hydrogen separation unit to separate additional hydrogen from the tail gas.

In a second aspect, a method of producing hydrogen comprises reforming a mixture of a steam and a feedstock containing carbon and hydrogen in a steam reforming unit to produce syngas comprising hydrogen, carbon dioxide, and at least one of methane and carbon monoxide; separating the syngas in at least one separation unit into at least a hydrogen rich stream and a tail gas stream comprising at least hydrogen and one or more of carbon dioxide, methane, and carbon monoxide; and recycling at least a portion of the tail gas stream into the steam reforming unit.

In some embodiments, recycling the at least a portion of the tail gas stream comprises mixing the at least a portion of the tail gas stream with the mixture of the steam and the feedstock in a line connected to the steam reforming unit.

In some embodiments, flue gases generated by the method do not contain carbon dioxide.

In some embodiments, a portion of the hydrogen rich stream is used as a combustion fuel for the steam reforming unit. In some embodiments, the portion of the hydrogen rich stream used as a combustion fuel comprises at least 40% of hydrogen entering the at least one separation unit.

In some embodiments, the method further comprises recompressing and recycling a portion of the tail gas stream into the at least one separation unit.

In some embodiments, the tail gas stream comprises at least one of carbon monoxide and methane. In some embodiments, the recycling causes carbon in the at least one of carbon monoxide and methane in the tail gas to be converted to carbon dioxide in the steam reforming unit. In some embodiments, the at least one separation unit comprises at least a carbon dioxide scrubber, and wherein carbon dioxide removed from the syngas at the carbon dioxide scrubber is sequestered. In some embodiments, any carbon compounds not removed from the syngas at the carbon dioxide scrubber are included in the at least a portion of the tail gas recycled into the steam reforming unit.

### BRIEF DESCRIPTION OF THE DRAWINGS

FIG. 1 schematically illustrates an example hydrogen production unit in accordance with the present technology.

### DETAILED DESCRIPTION

Steam reforming processes include reacting a hydrocarbon with steam and/or carbon dioxide over a catalyst to produce syngas, a mixture of hydrogen and oxides of carbon. The hydrogen content of the syngas is often increased by cooling the syngas and reacting it over a catalyst to convert some of its carbon monoxide and remaining water vapor to additional hydrogen and carbon dioxide. A final treatment is to separate the hydrogen product from the remainder of the syngas comprised of steam, CH₄, CO, and CO₂. The steam is condensed and separated by cooling the syngas and passing the resulting two-phase mixture through a gas-liquid separator. Hydrogen is then separated in a pressure swing adsorption (PSA) unit containing a molecular sieve, resulting in a high pressure outlet stream containing approximately 90% of the inlet hydrogen at greater than 99% purity and a low pressure outlet stream of “tail gas” comprising the remaining H₂, and CH₄, CO, and CO₂ constituents of the inlet syngas to the PSA unit.

The fuel value of the low-pressure tail gas is conveniently used to fulfill a large portion of low-pressure burner fuel requirements for heating the reformer. The process provides extremely high purity hydrogen used as a reactant in other processes. Conventional steam reforming processes are not effective, however, for lowering undesirable CO₂ emissions to the atmosphere of hydrocarbons used as fuels for heating or power generation compared to the emissions of burning the inlet feedstock.

CO₂ may be scrubbed from a gas mixture such as flue gas from combustion furnaces and electric power plants by which the CO₂ portion of a gas preferentially dissolves in a solvent or forms chemical or physical bonds with a liquid. Such methods include the cycling of the gas to be scrubbed between a low and/or high temperature or high- and low-pressure baths of amines, ammonia, hydroxides, or the like. Other methods of isolating CO₂ from other gas species include distillation and adsorption.

Although conventional CO₂ separation methods exist, they are not suitable for removing the CH₄ and CO components of the tail gas which is combusted to heat the reformer. Thus, conventional CO₂ separation methods still result in substantial CO₂ stack emissions. Removal of dilute CO₂ from a stack at atmospheric pressure is less effective and more expensive than its removal from a high concentration of CO₂ in a gas at high pressure.

It would be desirable to produce hydrogen by the relatively inexpensive steam reforming process while also capturing a high portion and preferably all the carbon contained in the feedstock in order to lower and preferably eliminate CO₂ emissions to the environment. In systems described herein, the carbon components of the feedstock are not exhausted to the atmosphere, but rather can be removed at high pressure as CO₂. This technology can prevent carbon emissions from a steam reformation facility. Other objectives of the present technology will be observed by one reasonably skilled in the art.

Conventional steam methane reforming (SMR) wisdom is to make as much hydrogen product for export as possible from a plant of a given size, to process the process gases no more than one time, and to burn all of the carbon entering the plant to provide heat for the reforming process. In contrast, the present technology substantially reduces or eliminates carbon emissions by departing from this conventional practice in some or all respects. Whereas about 89% of the hydrogen produced in the reformer is recovered as product hydrogen for export in conventional practices of SMR and PSA hydrogen production (with the other 11% being inseparable from the fuel used for heating), the present technology utilizes approximately 43% of the hydrogen produced in the reformer to be intentionally combusted for heating purposes. Accordingly, approximately 57% of the hydrogen at high purity is recovered as product hydrogen for export in embodiments of the present technology. This in turn entails the novel and counterintuitive consumption of some of the purified PSA hydrogen as fuel and the recycling of carbon (in the form of PSA tail gas) from the syngas to the reformer feedstock rather than combusting carbon in the SMR furnace or scrubbing carbon from flue and/or exhaust gasses. This sacrificial combustion of fully refined hydrogen product is non-intuitive to one skilled in the art. However, by the discretionary use of hydrogen as fuel, by recycling PSA tail gas to the reformer mixed feed, and by forgoing the combustion of carbon to heat the reforming process, the present technology differs substantially from the strategy and methods of conventional SMR processes and reduces or eliminates carbon emissions.

Mixed feed of steam and a hydrocarbon or other feedstock containing hydrogen and carbon is reformed over a catalyst to form a syngas. In some embodiments the syngas undergoes the following three separations. First, steam is separated from the syngas, preferably in a separate process by condensation of the steam followed by phase separation of condensed water from the syngas, producing a water outlet stream and a stream of the remaining syngas. Second, carbon dioxide is separated from the syngas, preferably in a separate process and preferably by preferential dissolution of carbon dioxide in a solvent such as an amine, producing a carbon dioxide rich outlet stream and a stream of the remaining syngas. Third, hydrogen is separated from the syngas, preferably in a separate process and preferably by PSA, producing a high-pressure outlet stream of enriched hydrogen and a low-pressure outlet stream (e.g., a tail gas stream) containing the remaining components of the syngas. The separations of water, carbon dioxide, and hydrogen may be performed in any sequence, combination, or subcombination, and by any alternative processes. In some embodiments, water is separated first, and hydrogen is separated last, such that the tail gas from the PSA unit contains substantial volume percentages of methane, carbon monoxide, and hydrogen, and nominal or trace volume percentages of steam and carbon dioxide. For example, in some embodiments the tail gas may be less than 1% steam and less than 5% CO₂ by volume.

The carbon dioxide outlet stream exits the process and may be sequestered or used for some purpose such as a chemical reactant or addition or to enhance the recovery of subterranean oil or natural gas.

The hydrogen rich stream from the PSA unit is separated into a first hydrogen stream used as a combustion fuel, such as for heating the reforming furnace, and a second hydrogen stream that is exported or used as a product for a purpose outside the steam reforming unit.

The first hydrogen stream may be turbo-expanded prior to entering the reforming furnace as a fuel. The first hydrogen stream may also be raised in temperature (e.g., by at least 50° C. and in some embodiments to at least 800° C.) prior to turbo-expansion at a temperature which may be less than 300° C. The turbo-expander may also perform useful work such as to drive a compressor or turn an electric generator, etc. The hydrogen may be expanded in multiple stages of alternating reheating and further expansion.

In some embodiments, the tail gas containing CH₄, CO, and H₂ is compressed and used as a feedstock in a steam reforming unit, such as the reforming unit described above.

In some embodiments, the tail gas stream is compressed and conveyed to a PSA unit, such the PSA unit described above, wherein hydrogen is separated from the other contents of the tail gas.

In some embodiments, the tail gas is compressed and divided into a first tail gas stream used as feed to a reformer and a second tail gas stream fed to a PSA unit for separation of hydrogen from the other contents of the second tail gas stream. The first tail gas stream can be used to purge the CH₄ and CO content of the syngas and tail gas. The second tail gas stream can be used to increase the recovery of hydrogen from the tail gas.

In some embodiments, nitrogen undesirably introduced with the feedstock is separated and purged from the second tail gas stream. For example, the second tail gas stream may be compressed and then subjected to membrane separation wherein nitrogen is retained by the membrane and H₂, CH₄, and CO permeate the membrane at a pressure suitable for entry into the reformer as feedstock.

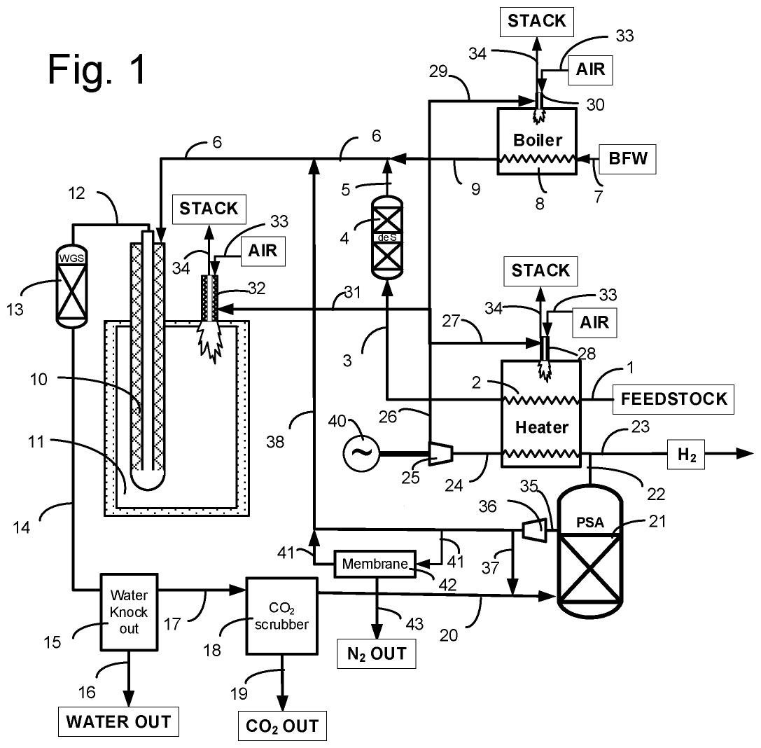

Referring now to FIG. 1, an example hydrogen production unit implementing carbon capture aspects of the present technology will be described. As shown in FIG. 1, line 1 conveys a hydrocarbon feedstock to a heater 2. Within the heater 2, the feedstock can be preheated to a temperature suitable for desulfurization. The preheated feedstock is conveyed by line 3 from the heater 2 to a desulfurization unit 4 wherein the feedstock is desulfurized. Line 5 conveys the desulfurized feedstock from desulfurization unit 4 to line 6 carrying steam, wherein the feedstock mixes with the steam in line 6. Line 7 conveys boiler feed water to a boiler 8 wherein the boiler feed water is raised to steam. Line 9 conveys the steam from the boiler 8 to line 6 wherein the steam mixes with the feedstock from line 5 to form a mixed feed. Line 6 conveys the mixed feed to a reforming reactor tube 10 wherein the mixed feed is heated and converted over a catalyst to a syngas containing H₂, CH₄, CO, CO₂, and steam. Reforming reactor tube 10 resides at least partially within, and is heated by, a furnace 11. Line 12 conveys the syngas from the reforming reactor tube 10 to a water gas shift (WGS) unit 13 wherein some of the CO and steam in the syngas react to form additional H₂ and CO₂. The syngas may be cooled from its peak temperature within the reforming reactor tube 10 to a lower temperature in line 12 and in WGS unit 13 via heat exchange against mixed feed within a bayonet reforming reactor tube 10 as shown, or via other forms of heat exchangers or coolers. Line 14 conveys the shifted syngas from the WGS unit 13 to a water knockout unit 15 wherein the syngas is cooled, some of the steam condenses to water from the syngas, and the condensed water is separated from the remaining syngas and exits via line 16. Line 17 conveys the syngas from the water knockout unit 15 to a carbon dioxide scrubber 18 wherein carbon dioxide is dissolved in an amine solvent at a first temperature and the solvent is isolated from the syngas and heated to a second temperature at which carbon dioxide comes out of solution in gaseous state. The separated CO₂ exits via line 19. The separated carbon dioxide may be further compressed for a specific use or for sequestration. The syngas in the carbon dioxide scrubber 18 may be at a pressure of greater than 10 bar. The carbon dioxide may be expelled at a pressure greater than 10 bar and preferably 30-60 bar.

Line 20 conveys syngas from the scrubber to a pressure swing adsorption (PSA) unit 21. Within the PSA unit 21, about 90% of the hydrogen (e.g., 89%) is separated from the remaining constituents of the syngas. Line 22 conveys high purity, high pressure hydrogen from the PSA unit 21 to line 23, and can be separated into 2 streams, for example, into lines 23 and 24. In some embodiments, line 24 conveys a portion of the hydrogen from line 22 through the heater 2 wherein the hydrogen is heated (e.g., to at least 300° C. and in some embodiments to at least 800° C.) and then conveyed to a turbo-expander 25 wherein the hydrogen expands and performs work. In some embodiments, the line 24 can carry about 40% of the hydrogen in line 22 form the PSA unit 21. In some embodiments, the line 24 can advantageously carry about 43% of the hydrogen in line 22. One of skill in the art, guided by this disclosure, will understand that the amount of the hydrogen product from line 22 can be varied as required to meet operational requirements. The turbo-expander 25 may provide power to turn an electric generator 40, for example. Line 26 conveys at least a portion of the expanded hydrogen from the turbo-expander 25 to line 27 and a regenerative burner 28 of the heater 2. Line 26 also conveys at least a portion of the expanded hydrogen from the turbo-expander 25 to line 29 and a regenerative burner 30 of the boiler 8. Line 26 further conveys at least a portion of the expanded hydrogen from the turbo-expander 25 to line 31 and a regenerative burner 32 of the furnace 11. Each of the said regenerative burners can be fed air by a line 33 and can exhaust cooled flue gas via line or stack 34.

Line 35 conveys low pressure tail gas from the PSA unit to a compressor 36 wherein the low pressure tail gas is compressed. As discussed above, the tail gas may include the remaining H₂, CH₄, CO, and CO₂ constituents of the inlet syngas. Line 38 conveys the compressed tail gas from the compressor 36 to line 6, wherein the compressed tail gas mixes with the other mixed feed to be reformed in the reforming reactor tube 10. Thus, as described herein, the carbon-rich tail gas can be recycled as a portion of the mixed feed to be reformed rather than being emitted, thus reducing or eliminating carbon emissions (e.g., CH₄, CO, and/or CO₂ emissions). Recycling carbon-rich tail gas can require a larger reforming reactor tube 10 than in conventional systems.

In some embodiments, line 41 may convey a portion of the compressed tail gas in line 38 through a membrane unit 42 and back to line 38 and to line 6 wherein the tail gas mixes with mixed feed and is conveyed into reformer tube 10. The membrane unit 42 can separate and purge some nitrogen introduced in the feedstock in line 1 from the tail gas. The purged nitrogen exits via line 43. Line 37 may convey some of the compressed tail gas from the compressor to line 20, which conveys it into the PSA unit 21 for additional hydrogen separation from the syngas.

Other advantages and other embodiments of the current invention will be obvious to those skilled in the art. Their omission here is not intended to exclude them from the claims advanced herein.

Although the present invention has been described in terms of certain preferred embodiments, various features of separate embodiments can be combined to form additional embodiments not expressly described. Moreover, other embodiments apparent to those of ordinary skill in the art after reading this disclosure are also within the scope of this disclosure. Furthermore, not all the features, aspects and advantages are necessarily required to practice the present technology. Thus, while the above detailed description has shown, described, and pointed out novel features of the present technology as applied to various embodiments, it will be understood that various omissions, substitutions, and changes in the form and details of the apparatus or process illustrated may be made by those of ordinary skill in the technology without departing from the spirit or scope of the present disclosure. The present technology may be embodied in other specific forms not explicitly described herein. The embodiments described above are to be considered in all respects as illustrative only and not restrictive in any manner.

What is claimed is:

1. A method of producing hydrogen, the method comprising:
reforming a mixture of a steam and a feedstock containing carbon and hydrogen in a steam reforming unit to produce syngas comprising hydrogen, carbon dioxide, and at least one of methane and carbon monoxide;
separating the syngas in at least one separation unit into a carbon dioxide rich stream, a hydrogen rich stream, and a tail gas stream containing remaining contents of the syngas; and
converting at least a portion of the tail gas stream to hydrogen and carbon dioxide.

2. The method of claim 1, wherein the at least a portion of the tail gas is recycled to the steam reforming unit wherein the at least a portion of the tail gas is converted to hydrogen and carbon dioxide.

3. The method of claim 2, wherein nitrogen is separated from the at least a portion of the tail gas before the at least a portion of the tail gas is recycled to the steam reforming unit.

4. The method of claim 1, wherein water is separated from the syngas in a water separator to produce an outlet stream of water and a stream containing remaining contents of the syngas entering the water separator.

5. The method of claim 1, wherein at least a portion of the hydrogen rich stream is used as a combustion fuel for the steam reforming unit.

6. The method of claim 4, wherein the at least a portion of the hydrogen rich stream is turbo-expanded to perform work before being used as the combustion fuel.

7. The method of claim 5, wherein a temperature of the at least a portion of the hydrogen rich stream is increased by at least 50° C. before being turbo-expanded.

8. The method of claim 1, wherein the carbon dioxide rich stream is separated from the syngas in a carbon dioxide separation unit, wherein the hydrogen rich stream is separated from remaining syngas in a hydrogen separation unit having the hydrogen rich outlet stream and the tail gas outlet stream, and wherein at least a portion of the tail gas stream from the hydrogen separation unit is compressed and fed into the hydrogen separation unit to separate additional hydrogen from the tail gas.

9. A method of producing hydrogen, the method comprising:
reforming a mixture of a steam and a feedstock containing carbon and hydrogen in a steam reforming unit to produce syngas comprising hydrogen, carbon dioxide, and at least one of methane and carbon monoxide;
separating the syngas in at least one separation unit into at least a hydrogen rich stream and a tail gas stream, the tail gas stream comprising at least hydrogen and one or more of carbon dioxide, methane, and carbon monoxide; and
recycling at least a portion of the tail gas stream into the steam reforming unit.

10. The method of claim 9, wherein recycling the at least a portion of the tail gas stream comprises mixing the at least a portion of the tail gas stream with the mixture of the steam and the feedstock in a line connected to the steam reforming unit.

11. The method of claim 9, wherein flue gases generated by the method do not contain carbon dioxide.

12. The method of claim 9, wherein a portion of the hydrogen rich stream is used as a combustion fuel for the steam reforming unit.

13. The method of claim 12, wherein the portion of the hydrogen rich stream used as a combustion fuel comprises at least 40% of hydrogen entering the at least one separation unit.

14. The method of claim 9, further comprising recompressing and recycling a portion of the tail gas stream into the at least one separation unit.

15. The method of claim 9, wherein the tail gas stream comprises at least one of carbon monoxide and methane.

16. The method of claim 15, wherein the recycling causes carbon in the at least one of carbon monoxide and methane in the tail gas to be converted to carbon dioxide in the steam reforming unit.

17. The method of claim 16, wherein the at least one separation unit comprises at least a carbon dioxide scrubber, and wherein carbon dioxide removed from the syngas at the carbon dioxide scrubber is sequestered.

18. The method of claim 17, wherein any carbon compounds not removed from the syngas at the carbon dioxide scrubber are included in the at least a portion of the tail gas recycled into the steam reforming unit.
